(19) United States
(12) Patent Application Publication
(10) Pub. No.: US 2006/0176797 A1
(43) Pub. Date: Aug. 10, 2006

(54) Apparatus for detecting minimum shift keying mark from optical disc and method thereof

(76) Inventors: Sergey Chekcheyev, Suwon-si (KR); Tatsuhiro Otsuka, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/305,324

(22) Filed: Dec. 19, 2005

(30) Foreign Application Priority Data
Dec. 17, 2004 (KR) 2004-107813

(51) Int. Cl. G11B 5/09

(52) U.S. Cl. 369/59.19; 369/59.22; 369/59.1

(57) ABSTRACT

Disclosed are an apparatus for detecting wobble information from an optical disc and a method thereof. The apparatus for detecting wobble information has a phase lock loop (PLL) for generating an oscillation signal with a frequency equal to that of a wobble signal having a minimum keying (MSK) mark; a control signal generator for generating at least one control signal in accordance with the oscillation signal; a memory for generating at least one heterodyne signal with a frequency equal to that of the MSK mark according to the at least one control signal; a multiplier for multiplying the wobble signal by the at least one heterodyne signal; an integrator for integrating the multiplied signal outputted from the multiplier, respectively; and a comparator for comparing each of the integrated values outputted from the integrators with a predetermined threshold to output a detection signal.

### CROSS-REFERENCE TO RELATED APPLICATIONS

This application claims benefit under 35 U.S.C. § 119(a) of Korean Patent Application No. 2004-107813, filed on Dec. 17, 2004, the entire contents of which are incorporated herein by reference.

### BACKGROUND OF THE INVENTION

1. Field of the Invention

The present invention relates to an apparatus for detecting wobble information from an optical disc and the method thereof. More particularly, the present invention relates to an apparatus for detecting a minimum shift keying (MSK) mark from the wobble signal of the optical disc.

2. Description of the Related Art

Generally, a spiraling and continuous guidance groove is formed on the surface of an optical disc such as DVD, for performing tracking. In case of a blue ray disc, a spiraled groove has a track pitch in 320 nm.

The groove is formed in a staggered pattern, hereinafter referred to as ‘wobbling’. The signal detected from the wobbling is called a ‘wobble signal’. The wobble signal includes not only tracking information for rotating the optical disc at a certain speed and writing or reading data along the track, but also information for generating a writing clock, timing information, address information and other information of the optical disc.

In writing data or reading the written data, it is important to detect such a wobble signal reliably. Especially, it is very important to accurately detect physical address information from the wobble signal when writing data to or reading the written data from the optical disc since a blue-ray disc, for example, has high density data written along its tracks.

In a blue-ray disc, the physical address information, which is one of the wobble information detected from the wobble signal, is written in an address in pre-groove (ADIP) in a wobble address scheme using a minimum shift keying modulation method.

Presently, to accurately detect a physical address information from a blue-ray disc, the MSK wobble scheme uses monotone wobble and MSK mark wobble. Further, a method of representing certain information by transforming the monotone wobble to saw-tooth wobble together based on the wobble addressing method using the MSK modulation method has been proposed. This method combines the saw-tooth wobble and the monotone wobble to form a wobble address format in which the MSK mark commonly represents the start point of an ADIP unit.

FIG. 1 is a block diagram representing an apparatus for detecting wobble information in accordance with the prior art. The apparatus detects the MSK mark from the wobble information, and includes a multiplier 10, a phase lock loop (PLL) 20, an integrator 30, a memory 40, a comparator 50 and a zero signal generator 60.

The multiplier 10 multiplies the signal outputted from the PLL 20 by the wobble signal which is an input signal. More specifically, the PLL 20 detects a carrier component from the wobble signal and outputs it to the multiplier 10, and the integrator 30 integrates the signal outputted from the multiplier 10. Further, the memory 40 temporarily stores the signal outputted from the integrator 30, thereafter outputting it to the comparator 50. The comparator 50 compares the signal with the zero signal outputted from the zero signal generator 60.

The MSK mark contained in the wobble signal replaces 3 periods of monotone wobble, which is a signal generated in accordance with the MSK modulation scheme, and represented by the following Equation 1.

$$M ( t ) = \{ \begin{matrix} cos ( 1.5 ω t ) , when 0 \leq t < 2 π / ω \\ - cos ( ω t ) , when 2 π / ω \leq t < 4 π / ω \\ - cos ( 1.5 ω t ) , when 4 π / ω \leq t \leq 6 π / ω\end{matrix} \qquad [ Equation 1 ]$$

in FIG. 2, the graph depicted with solid line shows the signal waveform of the MSK mark, which is represented as the above Equation 1.

The wobble signal, which is inputted to the multiplier 10 of the apparatus for detecting wobble information, is provided in the MSK signal or monotone wobble signal. Therefore, the multiplier 10 multiplies the MSK signal or monotone wobble signal by the signal outputted from the PLL 20, and the integrator 30 integrates the signal outputted from the multiplier 10 and inputs the result to the memory 40.

The signal outputted from the memory 40 is represented by the following Equation 2.

$${W}_{1} = \frac{ω}{2 π} {\int }_{0}^{6 π / ω} M ( t ) cos ω ⅆ t = - 0.5 , when MSK signal is present , \\ {W}_{0} = \frac{ω}{2 π} {\int }_{0}^{6 π / ω} cos ω t cos ω ⅆ t = 1.5 , when MSK signal is not present \qquad [ Equation 2 ]$$

It is understood that “W₁” and “W₀” have different signs from each other. Therefore, the comparator 50 detects such a change of signs to detect the MSK signal.

The frequency outputted from the PLL 20 is the same in calculation as the frequency of the wobble signal. However, since one MSK mark corresponds to 3 periods of the signal outputted from the PLL 20, the integration should be performed for 3 periods of the signal outputted from the PLL 20 in order to detect the MSK mark, resulting in greater effect of noise component.

Further, the performance of the prior art apparatus for detecting the wobble information varies considerably depending on the noise contained in the input signal and the performance of the PLL 20. However, the prior art apparatus for detecting the wobble information has higher error rate and lower SNR depending on the noise component contained in the wobble signal and the noise component of the signal outputted from the PLL 20. A need therefore exists for an apparatus and method for detecting wobble information that has improved performance with lower error rate and better SNR.

### SUMMARY OF THE INVENTION

The object of the present invention is to provide an apparatus for detecting wobble information with improved performance and method thereof by lowering the error rate including the noise in detecting the MSK mark.

To achieve the above object, the apparatus for detecting a wobble information according to the present invention comprises: a phase lock loop (PLL) for generating an oscillation signal with a frequency substantially equal to that of a wobble signal having a minimum keying (MSK) mark and input to the PLL; a control signal generator for generating at least one control signal in accordance with the oscillation signal; a memory for supplying at least one heterodyne signal with a frequency substantially equal to that of the MSK mark according to the at least one control signal; a multiplier for multiplying the wobble signal by the at least one heterodyne signal; an integrator for integrating multiplied signals outputted from the multiplier, respectively; and a comparator for comparing each of the integrated values outputted from the integrator with a predetermined threshold to output a detection signal.

Preferably, the control signal generator generates the at least one control signal for driving the memory by generating the at least one heterodyne signal every period of the oscillation signal.

Further, it is preferred that the memory provides each of heterodyne signals of which the respective periods thereof start essentially every period of the oscillation signal in accordance with the control signal, and which differ from each other in phase.

More preferably, the heterodyne signals generated in the memory are 3 signals, which differ from each other in phase by a ⅓ period.

More preferably, the heterodyne signals are represented as following equation:

$$H ( t ) = \{ \begin{matrix} cos ( 1.5 ω t ) - cos ω t , when 0 \leq t < 2 π / ω \\ - 2 cos ( ω t ) , when 2 π / ω \leq t < 4 π / ω \\ - cos ( 1.5 ω t ) - cos ω t , when 4 π / ω \leq t \leq 6 π / ω\end{matrix}$$

where t indicates time.

Further, it is preferred that the apparatus further comprises a clock generator for generating a local oscillation clock; and at least one counter for counting the clock in accordance with the at least one control signal to drive the memory.

Preferably, the apparatus further comprises a multiplexer for selectively outputting an integration value, when integration is completed as to one period of the heterodyne signal, among each of integration values outputted from the integrator.

More preferably, the apparatus further comprises a latch for storing the integration value outputted from the multiplexer and updating the integration value every period of the oscillation signal.

A method of detecting wobble information according to an exemplary embodiment of the present invention comprises steps of: generating an phase lock loop (PLL) oscillation signal with a frequency substantially equal to that of a wobble signal having a minimum shift keying (MSK) mark; generating at least one heterodyne signal with a frequency substantially equal to that of the MSK mark in accordance with the oscillation signal; multiplying the wobble signal as inputted by the at least one heterodyne signal to generate at least one multiplied signal one by one; integrating multiplied signals every period of the heterodyne signal to generate at least one integrated value, respectively; and comparing the at least one integrated value with a predetermined threshold to output an MSK detection signal.

Preferably, the method further comprises the step of generating a control signal for generating the at least one heterodyne signal one by one every period of the oscillation signal.

More preferably, the step of generating the heterodyne signal comprises supplying heterodyne signals of which their respective periods start with essentially every period and each of the heterodyne signals differs from each other in phase.

And, it is preferred that the heterodyne signals as generated are 3 signals, each of which differs from each other by ⅓ period in phase, and the period of the heterodyne signals falls in 3 periods of the oscillation signal.

More preferably, the heterodyne signals as generated are represented as follows:

$$H ( t ) = \{ \begin{matrix} cos ( 1.5 ω t ) - cos ω t , when 0 \leq t < 2 π / ω \\ - 2 cos ( ω t ) , when 2 π / ω \leq t < 4 π / ω \\ - cos ( 1.5 ω t ) - cos ω t , when 4 π / ω \leq t \leq 6 π / ω\end{matrix}$$

, where t indicates time.

Also, the step of generating the heterodyne signals comprises generating a local oscillation clock, counting the clock in accordance with each control signal, and generating the heterodyne signals every period of the oscillation signal.

Preferably, the method further comprises the step of selectively storing an integration value, when integration is completed as to one period of the heterodyne signal, among the each of integration values, wherein the step of comparing comprises comparing the integration value as stored with the threshold to output the detection signal.

Further, the step of storing the integration value comprises updating the integration value every period of the oscillation signal. Accordingly, the MSK mark is detected through a plurality of channels by adapting the certain heterodyne signal, thereby improving the detection accuracy.

### BRIEF DESCRIPTION OF THE DRAWINGS

The above aspects and features of the present invention will be more apparent by describing certain embodiments of the present invention with reference to the accompanying drawings, in which:

FIG. 1 is a block diagram for showing an apparatus for detecting a wobble information according to the prior art;

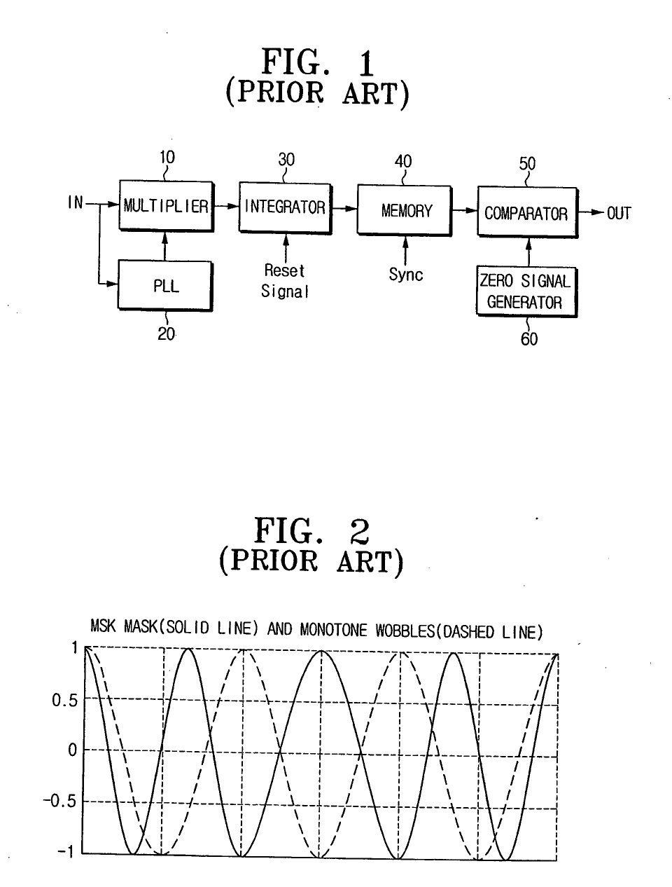

FIG. 2 illustrates a signal waveform of the MSK mark;

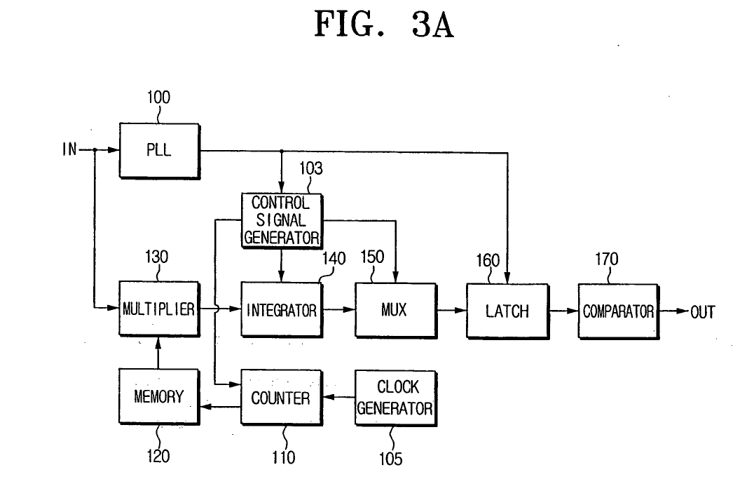

FIGS. 3A and 3B illustrate an apparatus for detecting a wobble information according to an exemplary embodiment of the present invention;

FIG. 4 illustrates a signal waveform generated by an apparatus for detecting a wobble information according to an exemplary embodiment of the present invention; and

FIG. 5 is a flowchart which explains operation of an apparatus for detecting a wobble information according to an exemplary embodiment of the present invention.

### DETAILED DESCRIPTION OF THE EXEMPLARY EMBODIMENTS

Certain embodiments of the present invention will be described in greater detail with reference to the accompanying drawings. In the drawings, the same or similar elements are denoted by the same reference numerals. In the following description, a detailed description of known functions and configurations has been omitted for conciseness.

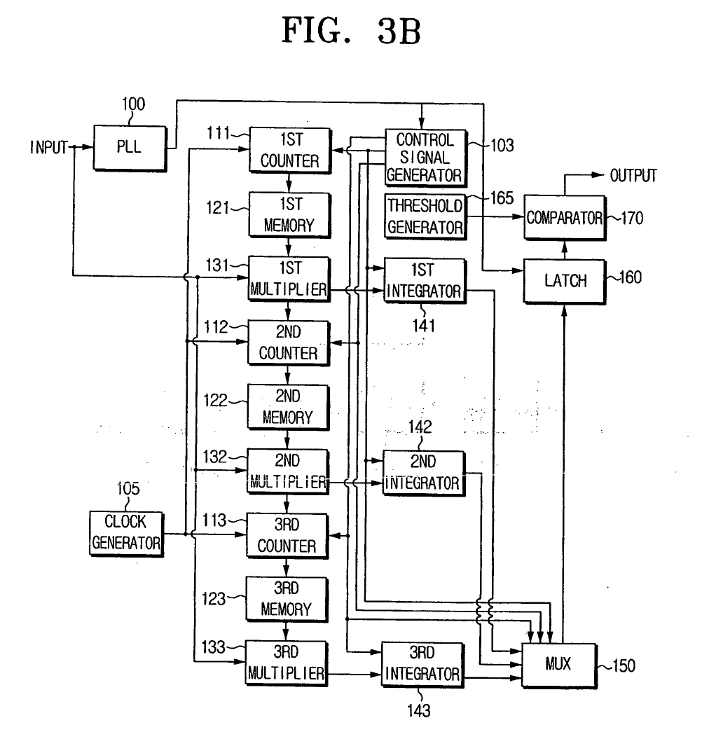

FIGS. 3A and 3B illustrate an apparatus for detecting wobble information according to an exemplary embodiment of the present invention.

The apparatus for detecting wobble information in accordance with an exemplary embodiment of the present invention comprises a PLL 100, a control signal generator 103, a clock generator 105, a counter 110, a memory 120, a multiplier 130, an integrator 140, a multiplexer 150, a latch 160 and a comparator 170.

The PLL 100 outputs a periodic signal with a frequency preferable and substantially equal to that of an input wobble signal. A control signal generator 103 generates a control signal for controlling operation of the counter 110, the integrator 140 and the multiplexer 150 in accordance with a period of the signal which is outputted from the PLL 100.

Also, according to one embodiment of the present invention, 3 channels are provided in a preferably parallel manner for detecting the MSK mark every period of the signal of the PLL 100 and focusing on it when the MSK mark falls in 3 periods of the signals outputted from PLL 100, thereby improving the performance of the MSK mark detection.

In this regard, the control signal generator 103 has 3 output ports. Each of the 3 output ports generate one of 3 control signals, respectively, in an alternating and circulating or round robin manner. In other words, the control signal generator 103 generates 3 control signals one by one preferably at the rising edge of the output signal of PLL 100, thereby allowing any one of 3 channels to act every 3 periods.

The clock generator 105 generates a local oscillation clock to synchronize the counter 110, which is described below. The counter 110 is synchronized with the clock generated in the clock generator 105 to perform the counting. The counter 110 comprises 3 counters (e.g., first, second and third counters 111, 112, 113 shown in FIG. 3B), each of which acts on the control signal generated from the control signal generator 103.

The memory 120 comprises 3 memories (e.g., first, second and third memories 121, 122, 123 shown in FIG. 3B) for providing respective ones of plural heterodyne signals every period of the output signal of the PLL 100, the heterodyne signals being characterized as shown by the following Equation 3.

$$H ( t ) = \{ \begin{matrix} cos ( 1.5 ω t ) - cos ω t , when 0 \leq t < 2 π / ω \\ - 2 cos ( ω t ) , when 2 π / ω \leq t < 4 π / ω \\ - cos ( 1.5 ω t ) - cos ω t , when 4 π / ω \leq t \leq 6 π / ω\end{matrix} \qquad [ Equation 3 ]$$

The signal frequency of a heterodyne signal stored in memory 120 is based on the output signal of the PLL 100, which is inputted from the counter 110.

The multiplier 130 comprises 3 multipliers (e.g., first, second and third multipliers 131, 132 and 133 shown in FIG. 3B), each of which multiplies the heterodyne signal input from each of the first, second and third memories 121, 122 and 123 of the memory 120 by the input wobble signal, respectively.

The integrator 140 comprises 3 integrators (e.g., first, second and third integrators 141, 142 and 143 shown in FIG. 3B), each of which integrates the signal which is outputted from each of the multipliers 131, 132 and 133 of the multiplier 130, respectively.

The multiplexer 150 selectively outputs one of the signals which are outputted from the first, second and third integrators 141, 142 and 143 of the integrator 140. The latch 160 holds the signal which is outputted from the multiplexer 150 for a predetermined time and outputs it to the comparator 170. Then, the comparator 170 compares the signal which is outputted from the latch 160 with a predetermined threshold to output an MSK detection signal. For that, a threshold generator 165 (FIG. 3B) may be provided for generating the threshold based on the noise and other channel condition, apart from the comparator 170.

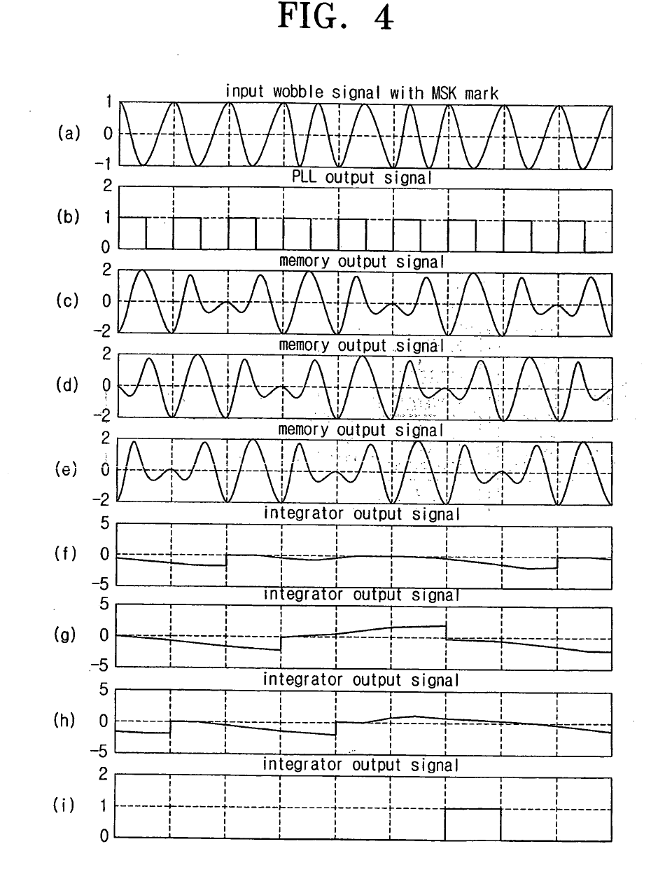

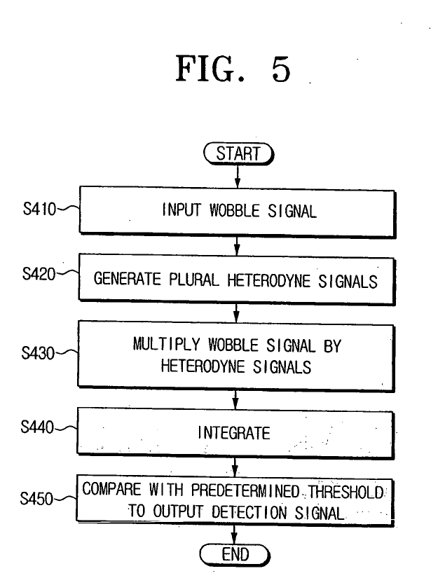

FIG. 4 illustrates a signal waveform generated by an apparatus for detecting wobble information according to an exemplary embodiment of the present invention. FIG. 5 is a flowchart which explains operation of an apparatus for detecting wobble information according to an exemplary embodiment of the present invention.

First, a wobble signal is inputted to the multiplier 130 and the PLL 100 (S410). Accordingly, the control signal generator 103 generates the control signal for driving the first, second and third counters 111, 112 and 113 of the counter 110 based on the period of the signal which is outputted from the PLL 100, one by one.

The signal (a) of FIG. 4 represents the waveform of the wobble signal, which comprises the MSK mark which is inputted to the multiplier 130 and the PLL 100, and the signal (b) represents the waveform of the signal which is outputted from the PLL 100. Referring to the above figures, the output signal of the PLL 100 is shifted by π/2 in phase but is preferably equal to the input wobble signal in frequency. It is understood that at the fourth period of the wobble signal, i.e. the fourth period of the output signal of the PLL 100, the MSK mark is shown for illustrative purposes.

Then, the memory 120 provides the heterodyne signals as represented in Equation 3 every period of the output signals of the PLL 100 (S420). Signals (c), (d), (e) of FIG. 4 represent the waveforms of heterodyne signals which are supplied from the first, second and third memories 121, 122 and 123, respectively.

As to the first counter 111, a control signal generator 103 resets the first counter 111 at the 3rd period, the 6th period and the 9th period based on the period of the output signal of the PLL 100 and generates the control signal so that it drives the first memory 121 to supply the heterodyne signal. Further, as to the second counter 112, a control signal generator 103 resets the second counter 112 at the 1st period, the 4th period and the 7th period based on the period of the output signal of the PLL 100 and generates the control signal so that it drives the second memory 122 to supply the heterodyne signal. As to the third counter 113, a control signal generator 103 resets the third counter 113 at the 2nd period, the 5th period and the 8th period based on the period of the output signal of the PLL 100 and generates the control signal so that it drives the third memory 123 to supply the heterodyne signal. That is, the heterodyne signals are outputted every period of the output signal of the PLL 100, but one memory will output a heterodyne signal in one period every 3 periods since 3 memories are provided. In this regard, the control signal generator 103 may be implemented as a register which outputs 3 output values in an alternating manner. That is, the control signal generator 103 can be a circular register having 3 output ports which are switched every period of the output signal of the PLL 100. When the rising edge of the output signal of the PLL 100 is inputted, the signal having logic 1 is generated in any one of the output ports of the circular register.

Therefore, each of the counters 111, 112 and 113 of the counter 110 is reset one by one based on the control signal which is generated based on the period of the PLL 100, thereby starting the counting operation. By counting in accordance with the period of the PLL 100, each of memories 121, 122 and 123 is driven so that the heterodyne signals are supplied one by one. Furthermore, the counter 110 drives each of memories 121, 122 and 123 based on the clocks generated from the clock generator 105.

The first, second and third multipliers 131, 132 and 133 of the multiplier 130 receive the heterodyne signals outputted from the corresponding first, second and third memories 121, 122 and 123 and to multiply each of the heterodyne signals by the wobble signal as inputted (S430).

Further, the first, second and third integrators 141, 142 and 143 of the integrator 140 receive the heterodyne signals outputted from the first, second and third corresponding multipliers 131, 132 and 133 to integrate each of them, finally outputting the result to the multiplexer 150 (S440).

The multiplexer 150 selectively outputs to the latch 160 the output signal from the integrator, of which the integration is completed as to one period of the heterodyne signals via alternating ones of the 3 integrators 141, 142 and 143. Therefore, the latch 160 will update the stored value every period of the wobble signal.

Signals (f), (g) and (h) of FIG. 4 represent the waveforms of the signals outputted from the first, second and third integrators 141, 142 and 143, respectively. In the third period, the integrator for which the integration is completed as to one period of the beterodyne signal is the second integrator 142 and, at this time, the value that is stored in the latch 160 is the one outputted from the second integrator 142.

Similarly, in the fourth period, the output from the third integrator 143 is stored in the latch 160. In the 5th period, the output from the first integrator 141 will be in the latch 160 and, in the 6th period, the output of the second integrator 142 will be in the latch 160.

Further, the comparator 170 outputs the detection signal for the MSK mark through comparison with a predetermined threshold (S450). The signal outputted from the comparator 170 is shown as Signal (i) of FIG. 4.

The threshold is preferably obtained through the experiment, and operation of the apparatus in accordance with an exemplary embodiment of the present invention, that is, a threshold is selected which is generally greater than “0” and smaller than the maximum value outputted from the integrator 140. In the present embodiment, the threshold generator 165 may be provided for generating the threshold.

In consideration of the input value from the latch 160 to the comparator 170 every period of the wobble signal referring to FIG. 4, the output value of the second integrator 142 in the third period is near zero, the output value of the third integrator 143 in 4th period is near zero, and the output value of the first integrator 141 in the 5th period is also near zero. However, the output value of the second integrator 142 in the 6th period is a peak value, i.e. exceeds a threshold, represented in Signal (g) of FIG. 4.

Further, referring to FIG. 4, in connection with the instant that a peak value appears in an integrator signal, the one period of the MSK mark contained in the wobble signal and the heterodyne signal generated in the second memory 122 is in the 4th period through the 6th period of the wobble signal, both of which occur within essentially the same instant in the occurring period.

Therefore, referring to FIG. 4, the signal outputted from the comparator 170 represents the waveform of Signal (i) which has the rising edge in essentially the same instant that the 6th period ends, i.e. the 7th period shows the rising edge.

Therefore, the MSK mark detection accuracy of the wobble information detection apparatus is improved by detecting the MSK mark every period of the wobble signal through 3 channels using the fact that the period of the MSK mark falls in 3 periods of the wobble signal.

Also, the signal from the latch 160 is represented using the following Equation 4:

$${L}_{1} = \frac{ω}{2 π} {\int }_{0}^{6 π / ω} M ( t ) H ( t ) ⅆ t = 2 , when MSK mark is present , \\ {L}_{0} = \frac{ω}{2 π} {\int }_{0}^{6 π / ω} H ( t ) cos ω t ⅆ t = - 2 , when MSK mark is absent \qquad [ Equation 4 ]$$

Therefore, in the apparatus for detecting a wobble information according to the present invention, when the MSK mark appears, the integration value is “|L₁−L₀|=4”, which is twice that of “|W₁−W₀|=2” in the prior art. Further, the noise component of the integration value is represented using the following Equation 5.

$$\frac{{N}_{L}}{{N}_{W}} = \frac{\sqrt{\frac{ω}{2 π} {\int }_{0}^{6 π / ω} {H}^{2} ( t ) ⅆ t}}{\sqrt{\frac{ω}{2 π} {\int }_{0}^{6 π / ω} {cos}^{2} ω t ⅆ t}} = \frac{0.2}{0.12} = 1.66 \qquad [ Equation 5 ]$$

Therefore, comparing a signal to noise ratio (SNR) of the apparatus for detecting wobble information according to the present invention with that of the prior art, the relation is shown using the following Equation 6.

$$\frac{\vert {L}_{1} - {L}_{2} \vert {N}_{W}}{\vert {W}_{1} - {W}_{0} \vert {N}_{L}} = \frac{4}{2} \frac{0.12}{0.2} = 1.2 \qquad [ Equation 6 ]$$

That is, the apparatus for detecting wobble information in accordance with an exemplary embodiment of the present invention adapts the heterodyne signal, thereby improving by 1.2 times in performance. It is well-known that, in case where SNR is low, the bit error rate varies greatly depending on the SNR. The apparatus for detecting wobble information according to the present invention, however, shows outstanding performance for the MSK detection even if the SNR of the wobble signal is low.

Therefore, the scheme of detecting wobble information according to the present invention shows not only very low bit error rate in comparison with that of the prior art, but also greatly improved detection performance.

In accordance with the present invention, the MSK mark is detected through a plurality of channels by adapting a certain heterodyne signal, thereby improving the detection accuracy. Further, the detection error is minimized so that the detection performance of the MSK mark is greatly improved.

As stated above, the embodiments are explained herein in detail, but it will be appreciated by those skilled in the art that many modifications are possible without departing from the scope of the present invention. Therefore, the present invention should not be defined by the explained embodiment, but by the following claims and their equivalents.

What is claimed is:

1. An apparatus for detecting a minimum shift keying (MSK) mark comprising:
a phase lock loop (PLL) for generating an oscillation signal with a frequency substantially equal to that of a wobble signal having a minimum keying mark and input to the PLL;
a control signal generator for generating at least one control signal in accordance with the oscillation signal;
a memory for providing at least one heterodyne signal with a frequency substantially equal to that of the MSK mark according to the at least one control signal;
a multiplier for multiplying the wobble signal by the at least one heterodyne signal;
an integrator for integrating multiplied signals outputted from the multiplier, respectively; and
a comparator for comparing each of the integrated values outputted from the integrator with a predetermined threshold to output a detection signal.

2. The apparatus of claim 1, wherein the control signal generator generates the at least one control signal for driving the memory by generating the at least one heterodyne signal every period of the oscillation signal.

3. The apparatus of claim 2, wherein the memory provides each of heterodyne signals of which their respective periods start essentially every period of the oscillation signal in accordance with the control signal, and which differ from each other in phase.

4. The apparatus of claim 3, wherein the heterodyne signals provided via the memory are 3 signals, which differ from each other in phase by a ⅓ period.

5. The apparatus of claim 3, wherein the heterodyne signals :are represented by following equation:
$$H ( t ) = \{ \begin{matrix} cos ( 1.5 ω t ) - cos ω t , when 0 \leq t < 2 π / ω \\ - 2 cos ( ω t ) , when 2 π / ω \leq t < 4 π / ω \\ - cos ( 1.5 ω t ) - cos ω t , when 4 π / ω \leq t \leq 6 π / ω\end{matrix}$$
where t indicates time.

6. The apparatus of claim 2, further comprising:
a clock generator for generating a local oscillation clock; and
at least one counter for counting the clock in accordance with the at least one control signal to drive the memory.

7. The apparatus of claim 1, further comprising:
a multiplexer for selectively outputting an integration value, when integration is completed as to one period of the heterodyne signal, among each of the integration values outputted from the integrator.

8. The apparatus of claim 7, further comprising:
a latch for storing the integration value outputted from the multiplexer and updating the integration value every period of the oscillation signal.

9. A method of detecting a minimum shift keying mark comprising the steps of:
generating a phase lock loop (PLL) oscillation signal with a frequency substantially equal to that of a wobble signal having a minimum shift keying (MSK) mark;
generating at least one heterodyne signal with a frequency substantially equal to that of the MSK mark in accordance with the oscillation signal;
multiplying the wobble signal as inputted by the at least one heterodyne signal to generate at least one multiplied signal one by one;
integrating multiplied signals every period of the at least one heterodyne signal to generate at least one integrated value, respectively; and
comparing the at least one integrated value with a predetermined threshold to output an MSK detection signal.

10. The method of claim 9, further comprising the step of:
generating a control signal for generating the at least one heterodyne signal one by one every period of the oscillation signal.

11. The method of claim 9, wherein the step of generating the heterodyne signal comprises supplying the heterodyne signals of which their respective periods start essentially every period and each of the heterodyne signals differs from each other in phase.

12. The method of claim 11, wherein the heterodyne signals as generated are 3 signals, each of which differs from each other by ⅓ period in phase, and the period of the heterodyne signals falls in 3 periods of the oscillation signal.

13. The method of claim 11, wherein the heterodyne signals as generated are represented as follows:
$$H ( t ) = \{ \begin{matrix} cos ( 1.5 ω t ) - cos ω t , when 0 \leq t < 2 π / ω \\ - 2 cos ( ω t ) , when 2 π / ω \leq t < 4 π / ω \\ - cos ( 1.5 ω t ) - cos ω t , when 4 π / ω \leq t \leq 6 π / ω\end{matrix}$$
where t indicates time.

14. The method of claim 10, wherein the step of generating the heterodyne signals comprises generating a local oscillation clock, counting the clock in accordance with each of the control signal, and generating the heterodyne signals every period of the oscillation signal.

15. The method of claim 9, further comprising the step of:
selectively storing an integration value, when integration is completed as to one period of the heterodyne signal, among the each of integration values, wherein the step of comparing comprises comparing the integration value as stored with the threshold to output the detection signal.

16. The method of claim 15, wherein the step of storing comprises updating the integration value every period of the oscillation signal.
